(19) United States
(12) Patent Application Publication
(10) Pub. No.: US 2006/0047591 A1
(43) Pub. Date: Mar. 2, 2006

(54) Method of capitalizing a distributed business entity and allocating profits thereof

(76) Inventor: Bradley D. Snouffer, York, PA (US)

Correspondence Address: Attn: Raymond Jones;IP Law Global, PC, PMB 5537, 11921 Freedom Drive, Suite 550, Reston, VA, 20190, US

(21) Appl. No.: 10/925,975

(22) Filed: Aug. 26, 2004

(51) Int. Cl. G06Q 40/00

(52) U.S. Cl. 705/35

(57) ABSTRACT

A method of capitalizing a distributed business entity and allocating profits includes forming a plurality of distributed offices under the direction of a managing entity, the distributed offices being organized to provide a service or product to customers. The managing entity sells percentage ownership interests in the distributed offices to qualified investors. Qualified investors are those businesses or professionals whose occupation normally provides all or a portion of the service or product to the customer. Profits accumulated in the distributed office are allocated to the qualified investors based on their respective percentage ownership interest in the distributed offices. The qualified investors can also earn their standard services fees for providing all or a portion of the service or product to the customer.

### BACKGROUND OF THE INVENTION

A prospective buyer of real estate must deal with numerous distributed service providers to find a property, close the transaction, inspect or build the property, fund the purchase, and insure the property. Examples of these service providers include, attorneys, real estate brokers & agents, builders, mortgage originators, title company personnel, insurance agents, appraisers, accountants, and financial planners. While all of these “service providers” earn service fees from the buyer for performing part of the real estate transaction, their earning potential is limited to those buyers/sellers they have direct contact with. Also, their earning potential is limited by not being able to participate in the revenues generated in the underlying mortgage on the property.

Recent changes in the mortgage industry are making it more difficult for small service providers and independent professionals to simultaneously run their companies and also produce their own business to compete with the larger companies in the consolidated real estate transaction marketplace. At the same time, one-stop real estate transaction service providers are a convenience the public is demanding. In a survey conducted by the National Association of Realtors, 78% of buyers said they would prefer to have a single source for their real estate and mortgage transactions, and 66% said they would choose a company or affiliated companies that offered this service. More importantly, 32% are willing to pay for this additional convenience.

Presently, small service providers and independent professionals have been hampered by the lack of their involvement in the comprehensive real estate transaction process, thereby limiting their revenue potential from the real estate closing/mortgage process, as well as precluding them from earning recurring profits generated by refinancing the initial mortgage transactions.

### SUMMARY OF THE INVENTION

The present invention provides a method of capitalizing a comprehensive real estate transaction process, whereby: (i) a managing entity provides ownership interests in each “distributed office” that are sold to “qualified investors,” (service providers affiliated with one or more aspects of the real estate transaction and mortgaging process);
(ii) revenue for each distributed office is accumulated through transactions initiated from at least one of the qualified investors or by referral from the managing entity; and (iii) profit for the respective distributed office is allocated to the qualified investors based solely on their pro rata ownership interest.

The method combines certain positive attributes of REIT's (Real Estate Investment Trusts) and Limited Partnerships (LP's), in that the method provides centralized direction and investment diversification. The method described herein, however, is superior to the LP or REIT forms of ownership by not compromising the direct, hands-on participation of real estate service providers (i.e., those qualified investors) inherent in a real estate closing/mortgage process.

The method also allows for leads flowing to the management entity to be dispersed to the distributed offices based on various allocation criteria, including geographic proximity of the customer and the distributed office, prior contact with a qualified investor, or other pre-defined criteria.

The method is further advantageous in that the investment in the distributed office is open-ended, meaning new closing/mortgage transactions are continually added to the pool existing in the distributed office to enhance the rate of return and profitability of the respective distributed office.

### BRIEF DESCRIPTION OF THE DRAWINGS

The advantages of the present invention will become more apparent by describing in detail the preferred embodiments thereof with reference to the attached drawings:

FIG. 1 is a block diagram of the overall structure of the managing entity, distributed offices and customers to carry out the methods described herein;

FIG. 2 is a block diagram of the business process interactions between the managing entity and each respective distributed office; and

FIG. 3 is a block diagram of the capitalization method and revenue allocation for each distributed office and the qualified investors.

### DETAILED DESCRIPTION OF THE INVENTION

The present invention will now be described more fully with reference to the accompanying drawings, in which preferred embodiments of the invention are shown. The method described herein broadly addresses initial business capitalization, diversified ownership and revenue/profit allocation associated with a real estate transaction and mortgage business process. The invention may, however, be embodied in many different forms and should not be construed as being limited to the real estate transactions set forth herein. Rather, the embodiments are provided so that this disclosure will be thorough and complete, and will fully convey the concept of the invention to those skilled in the art.

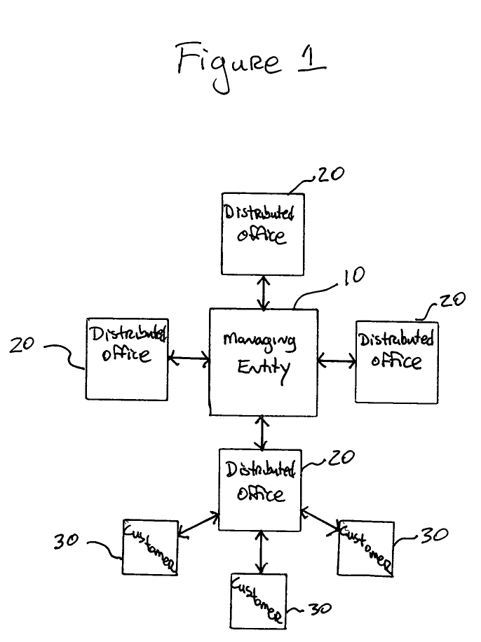

As shown in FIG. 1, the participants in the capitalization/revenue allocation method are a central managing entity 10, one or more distributed offices 20, and real estate customers 30. The managing entity 10 interfaces with each of the distributed offices 20, and the distributed offices 20 interface directly with their respective customers 30 while performing the conventional real estate closing and mortgaging business functions.

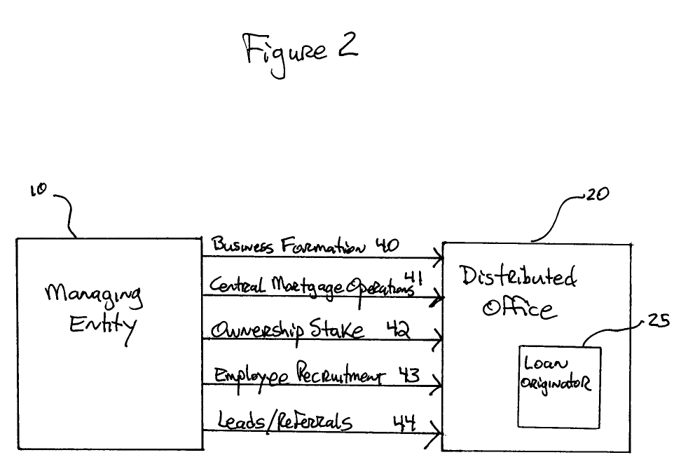

As shown in FIG. 2, the managing entity 10 will properly form the business entity 40 comprising the distributed offices 20, and operate each distributed office 20 in a manner similar to a branch operation. The managing entity 10 will perform certain centralized functions related to the mortgage closing process 41, including but not limited to providing facilities, computer support, administration, policy and procedures, underwriting, and clearance activities. The managing entity will maintain an ownership stake 42 in each distributed office, preferably 51%, but other lesser or greater percentages are contemplated. The 51% ownership stake, however, ensures a majority stake in each distributed office 20, thereby providing the managing entity 10 with the legal framework and authority to promote uniformity among the distributed offices 20.

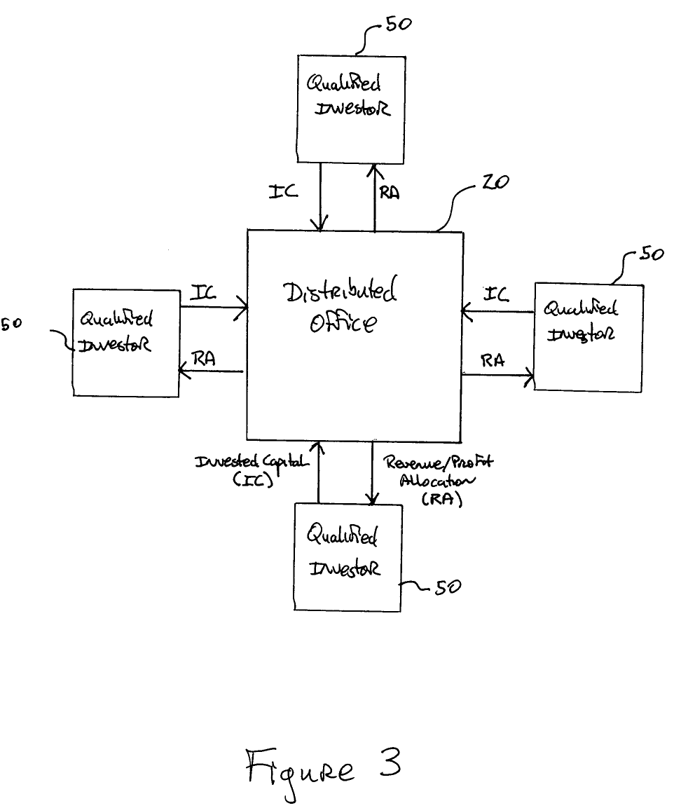

As shown in FIG. 3, for each distributed office 20, the remaining ownership stake not retained by the managing entity 10 will be made available for purchase by qualified investors 50. These qualified investors 50 are those service providers and professionals who are knowledgeable about the real estate, title, and/or mortgage industries, or whose occupation is within these industries. Such qualified investors would include attorneys, real estate brokers & agents, builders, mortgage originators, title company personnel, insurance agents, accountants, financial planners, etc.

By properly pricing the ownership percentage, the capitalization plan will create sufficient initial capital and net worth for each entity that is typical to the industry. For example, sufficient invested capital (IC) could be accumulated where each 1% ownership stake is $2,500 dollars. Although not a requirement, preferably the ownership stakes are sold in 1% increments, with a maximum limit of 25% ownership for any one qualified investor. A limit on ownership percentage has two advantages. First, it ensures that authority in each distributed office 20 is not concentrated in the hands of a few qualified investors whose self-interest my conflict with the interests of the managing entity 10. Second, the greater the diversity in ownership of the distributed office 20, the greater the number of potential customers 30 that can be reached by the personal network of each qualified investor 50 investing in the distributed office 20.

Once the distributed office 20 is formed and sale of a designated minimum percentage of ownership interest is achieved, the managing entity 10 will perform employee recruitment services 43 in an effort to hire at least one loan originator (LO) 25 for the distributed office 20. All of the production generated by the LOs 25 will be credited to the overall revenue production of the distributed office 20. Additional LO's 25 may be added as necessary. It will be the responsibility of the managing entity 10 to oversee the daily operations of each distributed office 20. It will be the responsibility of each LO 25 to follow all proven procedures to generate mortgage loan applications. These applications will come not only from the internal referrals from the qualified investors 50, but also from outside sources as well.

For example, the managing entity 10 will utilize approvals with the U.S. Department of Housing & Urban Development (HUD/FHA), the U.S. Department of Veteran's Affairs/Veteran's Administration (VA), and various other private finding sources to place mortgage loans. The decision of where to place a particular mortgage loan is based solely on the requirements of the customer 30. The managing entity 10 should have no exclusive arrangements with any of its finding sources. The managing entity 10 will preferably institute an ongoing program to seek out new finding sources that have mortgage loan products that will assist the distributed offices 20 in meeting the needs of more consumers 30, thus increasing the distributed office's ability to close more loans and increase profits.

Compliance with all present and future federal, state and local rules regarding mortgage disclosures and affiliated business arrangements will be the responsibility of the managing entity 10 in association with each distributed office 20 and their respective qualified investors 50.

The managing entity 10 may also conduct marketing functions to generate leads and referrals 44 for the respective distributed offices 20. Lead distribution from the managing entity 10 to one of the distributed offices 20 will be based on certain pre-defined criteria, such as the geographic proximity of the customer 30 to a respective distributed office 20, past contact with a qualified investor 50 in the distributed office 20, or other similar criteria.

Referring again to FIG. 3, the revenue/profit allocation (RA) of the distributed office 20 is based solely on ownership interest (invested capital IC) of the qualified investor 50 in the distributed office 20, not number of referrals, quality of referrals, or any other criteria not sanctioned by the federal, state or local governing bodies. Any new closing/mortgage transactions are continually added to the pool existing in the distributed office 20. Therefore, the more transactions that are performed in the distributed office 20, the greater the revenue/profit potential. Accordingly, each of the qualified investors 50 in a respective distributed office 20 has the incentive to locate, cross-sell, and refer as many customers 30 as possible to the distributed office 20.

As described herein, there are numerous individual and synergistic advantages to the method and structure of the invention.

(1) Diversified ownership. Investment participation in each distributed office 20 is not limited to a single company or profession. This allows all qualified investors 50 to benefit from production that is created outside of their own company affiliation, area of expertise, and/or the service they provide in any individual transaction in their respective marketplace(s).

(2) Geographic diversification. Qualified investors 50 can expand their profitability sources geographically. Assuming the managing entity 10 is properly authorized to do business in several lending jurisdictions, the LOs 25 of each distributed office 20 have the ability to originate loans in these additional jurisdictions that are outside of the qualified investor's 50 normal market place. For example, a qualified investor 50 may be located in the Commonwealth of Virginia and have relatives who live in the State of California. Should the qualified investor 50 refer this relative to their respective distributed office 20, the receiving distributed office 20 would be more profitable thus making the qualified investor's 50 return on their investment greater.

(3) Ability of service provider to achieve additional income based on ownership position. In addition to receiving their normal service fee, or service percentage, for performing their particular area of expertise (builder, agent, attorney, etc.), qualified investors 50 can offer mortgage financing as an additional offering as part of their service packages to facilitate one-stop shopping of packaged real estate services.

(4) Ability to share in subsequent financing activities by the initial buyer/seller. Most qualified investors 50 in a real estate transaction benefit only from the initial transaction and not from any subsequent transactions that can be generated from the initial business relationship with the customer 30. With the method of the invention, qualified investors 50 can thus benefit from both the initial mortgage purchase and any mortgage refinancing transactions. The average homeowner/customer 30 in most jurisdictions purchases a home every 5 to 7 years. This same customer 30 will normally refinance the home at least once during their ownership period. Most professionals involved exclusively in the purchase and sale of real property are normally prohibited from benefiting from these refinancing transactions. By having a profitability ownership interest in the distributed office 20, the qualified investor 50 benefits from these subsequent transactions.

(5) Ability to refer prospects to your distributed office 20, thereby increasing the profitability of the distributed office 20, and therefore increasing the value of the equity ownership. Any qualified investors 50 who refer business to their respective distributed office 20 would make that distributed office 20 more profitable thus making the return on investment greater. The greater the profitability of the distributed office 20, the greater the value of the qualified investor's 50 ownership interest.

(6) Ability of qualified investor 50 to provide services to the distributed office 20, and receive service income as well. In addition to the qualified investor 50 referring business to the distributed office 20, the managing entity 10 will generate business leads for the respective professional services of the qualified investors 50. These lead referral systems 44 (see FIG. 2) create additional transactions for both the distributed office 20 and the qualified investor 50, thus making both more profitable.

(7) The distributed office structure opens up mortgages as a profit center to all sizes of businesses and professionals. Under the method and structure of the invention, mortgages as a profit center is now made available to large, medium, and small businesses, as well as individual professionals.

(8) Ability to use ownership capital, plus profits, to create a pool of money for expansion into mortgage banking operations. Success in this capitalization and revenue method described herein will provide sufficient capital for the managing entity 10 to use both mortgage broker and mortgage banking services to place more competitive loans and close mortgage transactions, thereby increasing the profitability of each distributed office 20.

(9) Liquidity. While not traded on an open exchange, the liquidity of the ownership interests is somewhat facilitated, since the resale value on the ownership interest in the distributed office 20 is set by the value of the adjusted capital account of each distributed office 20, which can be readily ascertained.

While the present invention has been described in detail with reference to the preferred embodiments relating to real estate transactions, it should be understood by those skilled in the art that various changes, substitutions and alterations can be made hereto without departing from the scope of the invention as defined by the appended claims. For example, the method and structure disclosed herein are largely applicable in the investment and insurance transaction fields, for use by financial planners, stockbrokers or insurance agents.

What is claimed is:

1. A method of capitalizing a distributed business entity and allocating profits, the method comprising:
forming a plurality of distributed offices under the direction of a managing entity, the distributed offices being organized to provide a service or product to customers;
selling percentage ownership interests in the distributed offices to qualified investors, the qualified investor being one whose occupation provides all or a portion of the service or product to the customer;
accumulating revenue in the distributed offices by providing the service or product to the customer and determining profits thereof; and
allocating the profits to the qualified investors based on their respective percentage ownership interest in one of the plurality of distributed offices.

2. The method of claim 1, further comprising delivering, by the managing entity, customer leads to one of the distributed offices based on pre-defined criteria.

3. The method of claim 2, wherein the pre-defined criteria is a proximity of a geographic location of the customer and a geographic location of the distributed office.

4. The method of claim 1, wherein the selling of the percentage ownership interests in the distributed offices is limited to 49 percent.

5. The method of claim 1, wherein the each of the qualified investors is limited to a maximum ownership percentage of the distributed office.

6. The method of claim 5, wherein the maximum ownership percentage is 25 percent.

7. The method of claim 2, further including receiving, by the qualified investors, service fees associated with providing their respective portion of the service or product to the customer.

8. The method of claim 1, further comprising hiring a dedicated person to carry out business functions in the distributed office for the accumulating revenue step.
